(19) United States
(12) Patent Application Publication
(10) Pub. No.: US 2005/0244247 A1
(43) Pub. Date: Nov. 3, 2005

(54) Heat resistant drill screw

(75) Inventor: Katsumi Shinjo, Osaka (JP)

Correspondence Address: Hodgson Russ;Andrews Woods & Goodyear, Intellectual Property Practice Group, 1800 One M & T Plaza, Buffalo, NY, 14203, US

(73) Assignee: Shinjo Mfg. Co., Ltd., Osaka (JP)

(21) Appl. No.: 10/519,913

(22) PCT Filed: May 12, 2003
(86) PCT No.: PCT/JP03/05915

§ 371 Date: Dec. 30, 2004

(30) Foreign Application Priority Data
Jul. 4, 2002 (JP) 2002-195918

(51) Int. Cl. F16B 25/00

(52) U.S. Cl. 411/386

(57) ABSTRACT

A heat-resistant self drilling tapping screw adapted for drilling a stainless steel plate is proposed, which heat-resistant self drilling tapping screw has no delayed fracture and can satisfy high corrosion-resistivity and high tensile force. The heat-resistant self drilling tapping screw for drilling a stainless steel member, which includes a drill part 4, a tapping screw part 5 connected to the drill part 4, a fastening screw part 6 connected to the tapping screw part, and a screw head part 3 for conducting and providing a turning force; where the drill part 4 and the tapping screw part 5 are made of a high-carbon chrome series stainless steel, and the fastening screw part 6 including the screw head part 3 is made of a nickel series stainless steel.

### TECHNICAL FIELD

The present invention relates to a heat-resistant self drilling tapping screw made by bonding a nickel series stainless steel and a chrome series stainless steel, more specifically, to a heat-resistant self drilling tapping screw allowing local quenching, in which a drill part and a tapping screw part configured by the chrome series stainless steel are quenched to provide functions of both perforation function (drilling function) and tap function (tapping function) at extremely high level, and a tightening screw part and a screw head part configured by the nickel series stainless steel are not quenched to provide high intensity as well as high corrosion-resistivity without danger of delayed fracture.

### BACKGROUND TECHNOLOGY

As well known in the art, the self drilling tapping screws are screw members with a plurality of functions of performing perforation (drilling) per se, tapping (screw-thread cutting: tapping) per se, and screw fastening per se to the subject, and such that when fixing a metal panel such as a roof cover or a wall surface serving as the subject to the supporting steel, for example, perforation is performed to both the metal panel and the supporting steel to be the fixing point without providing a prepared hole to the metal panel and the supporting steel, while tapping is performed to the perforated hole, thus eventually fixing the relevant metal panel to the supporting steel by thread fastening. The self drilling tapping screws are used in large quantity since the prepared hole is not necessary. However, most of the conventional self drilling tapping screws provided is surface hardened by carburizing and quenching low-carbon steel.

The self drilling tapping screw is required to have several functions different mechanically and physically to respond to the intended use mentioned above. That is, the required function must be such having all of a perforation function for perforating the metal material and the like, a tapping function for tapping the metal material and the like, and a fastening function for fixing the metal panel to the supporting steel.

Recently, due to reasons of design for acid-rain countermeasures and structure of a facility, a stainless steel plate is being heavily used in place of the color steel plate. In this case, problems of low heat conductivity, delay of diffusion of frictional heat of the drill tip during perforation, and local temperature increase by thermal storage are present as properties of the stainless steel plate, and heat-resistivity of the self drilling tapping screw is required to solve such problems.

Further, in the self drilling tapping screw, in addition to the above mentioned five functional requirements, a structure capable of industrial mass production is also required as an important factor because the relevant self drilling tapping screw is consumed in large amount.

This type of self drilling tapping screw is standardized in detail in the item of the self drilling tapping screws in JIS-B1125-1990 in Japanese Industrial Standards (JIS). The self drilling tapping screw 1 is a screw member of a special structure including a shaft 2 and a head 3, which shaft 2 consists of a drilling part 4 with a perforation function, a tapping screw part 5 with a tapping (threaded cutting) function, and a fastening screw part 6 with a thread fastening joining function, and which head 3 consists of an engaging part 7 for engaging with a rotating tool.

The conventional typical self drilling tapping screw is formed by a low-carbon steel material having a carbon content of 16 carbons to 22 carbons, and after formation, is manufactured as such subjected to corrosion-resistant plating process after carburizing, hardening and quenching the surface layer. The surface quenching hardness obtained from the carbon steel material of the above low-carbon content is high, and for example, satisfies the hardness of the drill blade edge necessary to drill the metal panel and the supporting steel member.

The important point is, however, that for the quenching hardness of the carbon steel by carburization and the like, quenching slows down when subjected to thermal effect exceeding 200 degrees, thus lowering the quenching hardness and the blade edge becomes unusable. Particularly, the thermal effect on sharp locations such as the drill blade edge is significant, and as a result, the blade edge is rounded by friction and drilling can not be performed. As a countermeasure for such problem, in an aim to suppress heat generation during drilling, oil is applied to the drill tip, or the self drilling tapping screw made of SUS-410 stainless steel having the following problems has been used.

The SUS-410 stainless steel is a 13 chrome series stainless steel belonging to the field of heat-resistant steel based on the performance of chrome, and a significant lowering of hardness does not occur even if subjected to a heat exceeding 200 degrees, and drilling is secured (refer to JIS G4311 heat-resistant steel rod).

However, the self drilling tapping screw made of the above mentioned SUS-410 stainless steel has the following disadvantages. That is, the SUS-410 stainless steel has low carbon content (0.15% Max), and obtains drilling performance by carrying out surface hardening (equal to or above 800 Hv) by adding nitrogen to the furnace during quenching. However, even the quenching hardness obtained from the carbon content of such extent may become the cause of delay fracture if the hardness becomes 450 Hv at the deep part. Further, in reality, when the self drilling tapping screw made of SUS-410 stainless steel is used, shaft breaking and head flying accidents occur after fastening.

The surface hardness of the self drilling tapping screw to which low-carbon steel is carburized and quenched is very high but the internal hardness is suppressed to equal to or below 450 Hv in JIS. The reason for this is to prevent delayed fracture by intergranular corrosion under stress (shaft force) environment, but recently, it is reduced to equal to or below 400 Hv by ISO, the international standard, and reduction thereof is also being considered in JIS. Thus, the core hardness of 450 Hv when using SUS-410 is dangerous.

Further, the nitride layer of the surface lowers the corrosion-resistivity of the stainless steel of base metal, and has a disadvantage that corrosion-resistivity of the stainless steel can not be secured.

Therefore, the present invention, to solve each problem addressed in relation to the above conventional self drilling tapping screw, is proposed in view of the same, that is, proposes a heat-resistant self drilling tapping screw that has no delayed fracture and that satisfies high corrosion-resistivity and high tensile strength in proposing the heat-resistant self drilling tapping screw adapted to drilling the stainless steel plate.

In other words, the basic concept of the present invention is to propose a heat-resistant self drilling tapping screw in which the entire heat-resistant self drilling tapping screw is not formed with a single chrome series (400 series) stainless steel or quenched entirely, and which avoids chrome of low carbon series by the surface hardness method, forms the drill part and the tapping screw part adjacent to the drill part with the chrome series high-carbon stainless steel, and forms the fastening screw part including the screw head part with the nickel series (300 series) stainless steel to allow drilling of the stainless steel plate, and further to obtain higher corrosion-resistivity than the SUS-410 stainless steel.

### DISCLOSURE OF THE INVENTION

The present invention, to achieve the above aims, more specifically, configures a heat-resistant self drilling tapping screw for drilling a stainless steel member, the heat-resistant self drilling tapping screw including a drill part, a tapping screw part connected to the drill part, a fastening screw part connected to the tapping screw part, and a screw head part for conducting and providing a turning force; where the drill part and the tapping screw part are made of a high-carbon chrome series stainless steel of heat-resistant steel, and the fastening screw part including the screw head part are made of a nickel series stainless steel.

Further, the present invention configures the heat-resistant self drilling tapping screw in which the drill part and the tapping screw part connected to the drill part are SUS-420J2 with the carbon content being substantially equal to the carbon content (0.32 to 0.38) corresponding to S-35C or the carbon content (0.35 to 0.41) corresponding to S-38C in JIS-G4051 (carbon steels for machine structural use).

Additionally, the present invention configures the heat-resistant self drilling tapping screw in which the nickel series stainless steel of the fastening screw part including the screw head part is a stainless steel satisfying high corrosion-resistivity and high tensile force guaranteeing ISO A-2-70 and A-4-70 after thread rolling.

Further, the present invention configures the heat-resistant self drilling tapping screw in which the fastening screw part including the screw head part is made of SUS-305J1 or SUS-316.

Further, the present invention configures the heat-resistant self drilling tapping screw in which the drill part and the tapping screw part connected to the drill part are quench hardened by high-frequency heating.

Further, the present invention configures the heat-resistant self drilling tapping screw in which the chrome series stainless steel configuring the drill part and the tapping screw part connected to the drill part, and the nickel series stainless steel configuring the fastening screw part including the screw head part are integrally bonded into a rivet shape by resistance welding, to form each of the parts.

### BRIEF DESCRIPTION OF THE DRAWINGS

FIG. 1 shows a specific configuration example of a heat-resistant self drilling tapping screw according to the present invention;

FIG. 1A is a schematic side view showing an initial state and a step of joining two members, the two members being a first configuration member Ml made of a chrome series stainless steel and a second configuration member M2 made of a nickel series stainless steel;

FIG. 1B is a schematic side view showing a step of cold forging the drill blade after joining the first and second configuration members;

FIG. 1C is a schematic side view showing a step of rolling the screw part in the self drilling tapping screw and removing the scraps; and

FIG. 1D is a schematic side view showing both a high-frequency heating step to the drill blade and the tapping screw part, as well as the quenching medium tank for quenching.

### DETAILED DESCRIPTION OF THE PREFERRED EMBODIMENTS

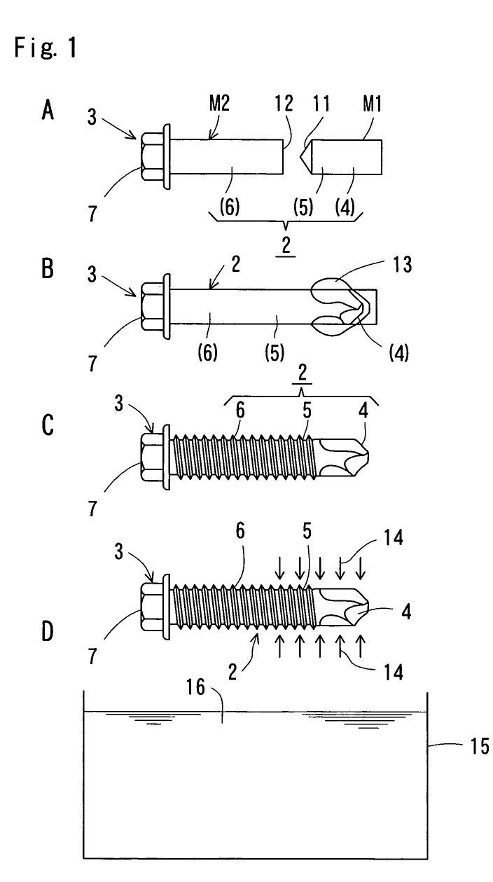

The heat-resistant self drilling tapping screw of the present invention will now be described in detail based on specific embodiments shown in the figures. FIG. 1 shows a specific configuration example of the heat-resistant self drilling tapping screw according to the present invention, FIG. 1A is a schematic side view showing an initial state and a step of joining the two members, the two members being a first configuration member Ml made of a chrome stainless steel and a second configuration member M2 made of a nickel stainless steel, FIG. 1B is a schematic side view showing a step of cold forging the drill blade after joining the first and second configuration members, FIG. 1C is a schematic side view showing a step of rolling the screw part in the heat-resistant self drilling tapping screw and removing the scraps, and FIG. 1D is a schematic side view showing a high-frequency heating step to the drill blade and the tapping screw part, as well as the quenching medium tank for quenching.

The important point in the present invention is that the heat-resistant self drilling tapping screw 1 of the present invention is configured by a first configuration member M1 made of a chrome series stainless steel, and a second configuration member M2 made of a nickel series stainless steel, as formed in the configuration shown in FIG. 1A, in advance. In other words, the present invention provides the heat-resistant self drilling tapping screw, which configuration is not formed entirely with a single chrome series (400 series) stainless steel, or quenched entirely, and which avoids chrome steel of low-carbon series by surface hardening method, and has the drill part 4 and the tapping screw part 5 connected to the drill part 4 made of the chrome series (400 series) high-carbon stainless steel of heat-resistant steel, and the fastening screw part 6 including the screw head part 3 made of the nickel series (300 series) stainless steel, thereby allowing drilling to be effectively performed even to the stainless steel plate, and obtaining higher corrosion-resistivity than the self drilling tapping screw made of SUS-410.

On the other hand, the fastening screw part 6 including the above mentioned screw head part 3 is the nickel series (300 series) stainless steel, and is formed by SUS-305J1 or SUS-316 that can satisfy A2-70 and A4-70 of ISO, the international standard, for the high tensile force of the screw made of stainless steel after thread rolling. The tensile force of the above ISO-A2-70 or A4-70 can be satisfied with work hardening by wire drawing or work hardening by drawing during header working, and thread rolling.

Further, more specifically, the chrome series (400 series) high-carbon stainless steel forming the drill part 4 and the tapping screw part 5 connected to the drill part 4 is SUS-420J2, and the carbon content thereof is preferably carbon content (0.32 to 0.38) same as S-35C or carbon content (0.35 to 0.41) same as S-38C by JIS G4051 (carbon steels for machine structural use). The hardness equal to or greater than 600 Hv necessary for drilling can be readily secured due to such carbon content without the surface hardening method.

Further, in the present invention, quenching of the chrome series (400 series) high-carbon stainless steel forming the drill part 4 and the tapping screw part 5 connected to the drill part 4 is carried out by means of water cooling by local heating with high-frequency, and thus the fastening screw part 6 including the screw head part 3 is substantially not thermally effected, and therefore, the characteristic of the nickel series (300 series) stainless steel is not affected, and the performance thereof can be exhibited.

The first configuration member M1 is configured by a lot having a linear dimension configuring one part of the screw shaft 2, that is, the part corresponding to the drill part 4 and the tapping screw part 5 in the completed heat-resistant self drilling tapping screw 1, and includes an electric resistance welding projection 11 at one end in the shaft direction. The second configuration member M2, on the other hand, is configured by a lot having a linear dimension configuring the screw head part 3 and one part of the screw shaft 2, that is, the part corresponding to the fastening screw part 6 with a thread-fastening fastening function in the completed heat-resistant self drilling tapping screw 1, and includes an electric resistance welding end 12 at one end in the shaft direction.

The first configuration member Ml and the second configuration member M2 are integrally joined and coupled by means of electric resistance welding, with the electric resistance welding projection 11 in the first configuration member Ml and the electric resistance welding end 12 in the second configuration member M2 confronting in the shaft direction.

After integrally joining and coupling by electric resistance welding, the drill part 4 in the heat-resistance self drilling tapping screw 1 is processed by cold forging (refer to FIG. 1B). In this case, the scraps 13 produced by cold forging are appropriately removed. On the other hand, the screw part in the heat-resistant self drilling tapping screw 1 is formed by rolling process, thereby forming the tapping screw part 5 as well as the fastening screw part 6 (refer to FIG. 1C).

Subsequently, the important aspect of the present invention is in the quenching process to the heat-resistance self drilling tapping screw formed as above. In the present invention, the quenching process to the heat-resistance self drilling tapping screw 1 is performed locally (partially) by induction hardening process 14. The induction hardening is a hardening process that rapidly heats the surface of the steel member by high-frequency induced current, and then rapidly cools the same in the quenching medium 16 in the quenching tank 15.

### INDUSTRIAL APPLICABILITY

The heat-resistance self drilling tapping screw of the present invention of the above mentioned configuration forms, by configuring the heat-resistance self drilling tapping screw with two members of a first configuration member made of a chrome series stainless steel and a second configuration member made of a nickel series stainless steel; by integrally coupling and joining the first configuration member and the second configuration member; by configuring the drill part and the tapping screw part of the screw shaft with the first configuration member and configuring the fastening screw part and the screw head part of the screw shaft with the second configuration member; and further by quench hardening the part made of the first configuration member by high-frequency heating, the fastening screw part and the screw head part of the screw shaft to a mechanically tenacious structure and locally (partially) quenches and hardens the drill part and the tapping screw part of the screw shaft, and thus functions extremely effective as the self drilling tapping screw particularly, as the heat-resistance self drilling tapping screw adapted to drilling the stainless steel plate, with various functions of perforation function (drilling function), tap function (tapping function), and corrosion-resistance function at an extremely high level,

1-6. (canceled)

7. A heat-resistant self drilling tapping screw for drilling a stainless steel member; the heat-resistant self drilling tapping screw comprising:
a drill part;
a tapping screw part connected to the drill part;
a fastening screw part connected to the tapping screw part; and
a screw head part for conducting and providing a turning force, wherein
the drill part and the tapping screw part are made of a high-carbon chrome series stainless steel of heat-resistant steel;
the fastening screw part including the screw head part is made of a nickel series stainless steel;
the drill part and the tapping screw part connected to the drill part are SUS-420J2 with the carbon content being substantially equal to the carbon content (0.32 to 0.38) corresponding to S-35C or the carbon content (0.35 to 0.41) corresponding to S-38C in JIS-G4051 (carbon steels for machine structural use); and
the nickel series stainless steel of the fastening screw part including the screw head part is SUS-30J1 or SUS-316 and consists of a stainless steel satisfying high corrosion-resistivity and high tensile force guaranteeing ISO A-2-70 and A-4-70 after thread rolling.
